(19) United States
(12) Patent Application Publication
(10) Pub. No.: US 2010/0213007 A1
(43) Pub. Date: Aug. 26, 2010

(54) LADDER SYSTEM

(76) Inventor: Michael T. Richards, Salt Lake City, UT (US)

Correspondence Address: DAVID R. MCKINNEY, P.C., P.O. BOX 1460, SANDY, UT, 84091, US

(21) Appl. No.: 12/713,653

(22) Filed: Feb. 26, 2010

Related U.S. Application Data
(60) Provisional application No. 61/155,878, filed on Feb. 26, 2009.

(51) Int. Cl. E06C 7/18

(52) U.S. Cl. 182/107

(57) ABSTRACT

A ladder attachment includes an outrigger frame, having a unitary body, removably attachable to opposing side rails and at least one rung of a ladder, and a pair of length-adjustable outriggers, extending from the outrigger frame. The outriggers are pivotable in two degrees of freedom relative to the outrigger frame, and have a bearing pad attached at a distal end thereof.

### PRIORITY CLAIM

The present application claims priority from U.S. Provisional Patent Application Ser. No. 61/155,878, filed on Feb. 26, 2009, and entitled QUICK LADDER.

### BACKGROUND

1. Field of the Invention

The present invention relates generally to ladders. More particularly, the present invention relates to a ladder system having extendable outriggers that are adjustable in two degrees of freedom.

2. Related Art

One of the most common types of ladders is the extension ladder. Extension ladders are routinely used for maintenance, construction, painting, and other tasks that require a user to ascend to an elevated location to work. Extension ladders are used by extending an upper sliding ladder portion upward to a locked position against a base ladder portion, and leaning the top of the upper portion against a wall or other elevated structure. When using an extension ladder in this way, it is often desirable to have two individuals present—one to hold the base of the ladder steady, and the other to climb the ladder to work. This can be inconvenient, because there are many times when use of a ladder is needed, but two people are not available.

Additionally, typical extension ladders are frequently rested against the structure being worked upon. Unfortunately, this can hinder the ability of the user to work on the surface directly in front of them. In other cases, a desired position of an extension ladder can place the top of the ladder against a window or other potentially hazardous location in order to complete a job. Sometimes a ladder user must choose between an unstable ladder footing that places the ladder close to the work location, or a stable ladder position that places the ladder in an awkward position relative to the work location. Any of the above situations can be dangerous, both to property and to the safety of the worker.

### SUMMARY

It has been recognized that it would be advantageous to develop a ladder system that can be easily and safely used by one person.

It has also been recognized that it would be advantageous to have a ladder system that reduces obstruction of surfaces near the top of the ladder, and can be safely used in a variety of configurations.

In accordance with one embodiment thereof, the present invention provides a ladder system, including a ladder, having a pair of side rails and a plurality of rungs fixedly extending between the side rails. A first outrigger frame, having a unitary body, is removably attached to both side rails and at least one rung of the ladder. A pair of length-adjustable outriggers extend from the first outrigger frame. The outriggers are pivotable in two degrees of freedom relative to the first outrigger frame, and have a bearing pad attached at their distal ends.

In accordance with another aspect thereof, the invention provides provides a ladder attachment including an outrigger frame, having a unitary body, removably attachable to opposing side rails and at least one rung of a ladder, and a pair of length-adjustable outriggers, extending from the outrigger frame. The outriggers are pivotable in two degrees of freedom relative to the outrigger frame, and have a bearing pad attached at their distal ends.

In accordance with yet another aspect thereof, the invention provides a. ladder, including a ladder section having a pair of side rails and rungs fixedly extending substantially perpendicularly between the side rails. A first pair of length-adjustable outriggers extend from each side rail. The outriggers are pivotable in two degrees of freedom relative to the side rails, and have a bearing pad attached at their distal ends.

### BRIEF DESCRIPTION OF THE DRAWINGS

Additional features and advantages of the invention will be apparent from the detailed description which follows, taken in conjunction with the accompanying drawings, which together illustrate, by way of example, features of the invention, and wherein:

FIG. 1A is a side view of an embodiment of a ladder system in accordance with the present disclosure, with an adjustable outrigger attachment near the bottom for stabilizing the ladder on an uneven surface, and an outrigger attachment near the top for supporting the top of the ladder away from a support wall surface;

FIG. 1B is a side view of an embodiment of a ladder system in accordance with the present disclosure, with an adjustable outrigger attachment near the bottom for stabilizing the ladder on a sloping roof surface, and an outrigger attachment near the top for supporting the top of the ladder upon a sloping roof surface;

FIG. 2 is a close-up perspective view of an embodiment of a ladder system in accordance with the present disclosure, showing an adjustable outrigger attachment near the bottom for stabilizing the ladder;

FIG. 3 is a perspective view of an embodiment of an adjustable outrigger attachment for a ladder in accordance with the present disclosure;

FIG. 4 is a perspective view of multiple adjustable outrigger attachments for a ladder in accordance with the present disclosure, showing the outriggers in multiple different positions;

FIG. 5 is a close-up perspective view of an embodiment of an adjustable outrigger attachment for a ladder in accordance with the present disclosure, showing the ladder attachment hooks and outrigger pivoting mechanism;

FIG. 6 is a perspective view of a ladder with an embodiment of an adjustable outrigger attachment attached near the top of the ladder, with the outriggers extended laterally to provide bearing on opposing sides of a window;

FIG. 7 is a perspective view of a ladder section with an embodiment of an adjustable outrigger attachment positioned near an end of the ladder, and the outriggers extending beyond the end of the ladder;

FIG. 8 is an elevation view of a wall with a ladder with outriggers extending beyond upward to bear upon an eave above some windows;

FIG. 9 is a view of a bottom section of a ladder having an embodiment of an adjustable outrigger attachment attached thereto, having the outriggers positioned to function as leg levelers for the ladder; and

FIG. 10 is a perspective view of a ladder section with an embodiment of an adjustable outrigger attachment positioned near the bottom of the ladder, and the outriggers folded inward toward the side rails of the ladder.

### DETAILED DESCRIPTION

Reference will now be made to exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

As noted above, extension ladders are routinely used for maintenance, construction, painting, and other tasks that require a user to ascend to an elevated location to work. An extension ladder generally includes a two slidingly connected ladder portions, including a base ladder portion and an upper ladder portion. The bottom of the base portion frequently includes pivoting feet or other devices that help provide traction when the base of the ladder is placed against the ground. The upper portions when the base Extension ladders are used by extending an upper sliding ladder portion upward to a locked position against a base ladder portion, and leaning the top of the upper portion against a wall or other elevated structure. When using an extension ladder in this way, it is often desirable to have two individuals present—one to hold the base of the ladder steady, and the other to climb the ladder to work. This can be inconvenient, because there are many times when use of a ladder is needed, but two people are not available.

Additionally, typical extension ladders are frequently rested against the structure being worked upon. Unfortunately, this can hinder the ability of the user to work on the surface directly in front of them. In other cases, a desired position of an extension ladder can place the top of the ladder against a window or other potentially hazardous location in order to complete a job. Sometimes a ladder user must choose between an unstable ladder footing that places the ladder close to the work location, or a stable ladder position that places the ladder in an awkward position relative to the work location. Any of the above situations can be dangerous, both to property and to the safety of the worker.

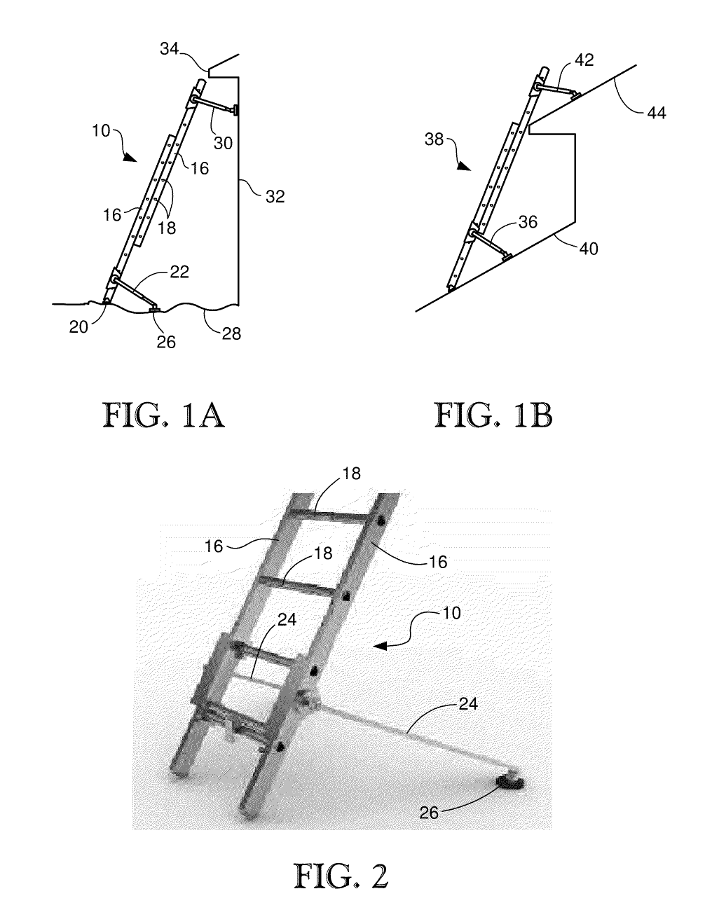

Advantageously, the inventor has developed a versatile ladder system that can help to stabilize a ladder in a wide variety of situations, and can also extend the functionality of the ladder in a variety of ways. Shown in FIGS. 1A and 1B are a side views of two embodiments of an extension ladder 10 that is provided with adjustable outriggers 12. As with common extension ladders, the ladder includes a lower ladder section 14 and an upper ladder section, the two sections being slidably attached together in the well known manner of extension ladders. Each ladder section includes a pair of side rails 16 and a plurality of rungs 18 fixedly extending substantially perpendicularly between the side rails. The ladder can include pivoting feet 20 at the bottom of the lower section, for providing a secure base when the ladder is leaned against an elevated surface or structure. Extension ladders are commonly made of aluminum or fiberglass, but other materials are also used, and the invention disclosed herein is not limited to use with ladders of these materials. For example, the system disclosed herein can be used with ladders of wood, steel, or other materials.

As noted above, sometimes the bearing feet 20 of a ladder are not sufficient to support the ladder in a safe and stable manner, depending upon the conditions around the ladder or the intended use of the ladder. Accordingly, the ladder system disclosed herein includes length-adjustable outriggers that can extend from each side rail of the ladder. As shown in FIG. 1A, the ladder includes a first pair of outriggers 22 that extend from the lower region of the ladder. The outriggers each include a length adjustable arm, with a bearing pad 26 at the distal end of the arm. In the embodiment of FIG. 1A, the first outriggers are attached near the bottom of the ladder 10 and extended for stabilizing the ladder on an uneven ground surface 28. This type of configuration is shown more clearly in FIG. 2. The outriggers 22 are pivotable in two degrees of freedom relative to the side rails 16, and can extend laterally and forwardly of the side rails to provide a more stable bearing condition at the base of the ladder.

Referring back to FIG. 1A, a ladder 10 can also include a second pair of length-adjustable outriggers 30 extending from each side rail 16 near the top of the ladder. Like the first outriggers, the second outriggers are pivotable in two degrees of freedom relative to the side rails, and have a bearing pad attached at their distal ends. Unlike the lower outriggers, these outriggers are extended out near the top of the ladder for supporting the top of the ladder away from a support wall surface 32. This type of support is often referred to as a standoff, and can be desirable for safe and convenient access to the fascia 34 of overhanging eaves, and the like.

In the embodiment of FIG. 1B, a pair of lower adjustable outriggers 36 are attached at a different location near the bottom of an extension ladder 38 and are configured for stabilizing the base of the ladder on a lower sloping roof surface 40. This ladder also includes an upper pair of outriggers 42 that are attached near the top of the ladder and extended forward for supporting the top of the ladder upon an upper sloping roof surface 44. In certain circumstances, resting the base of an extension ladder on a sloping roof in this way can be done safely with the use of the outrigger system disclosed herein.

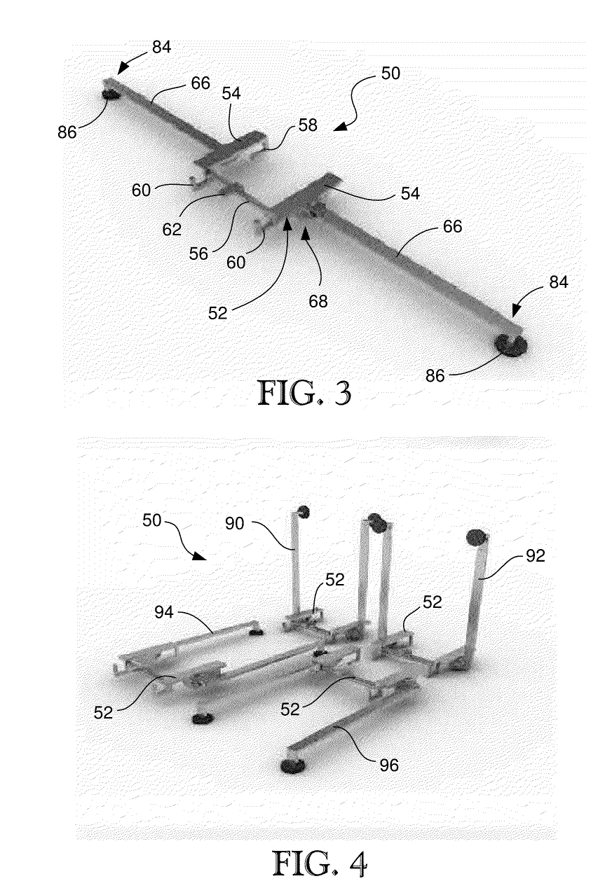

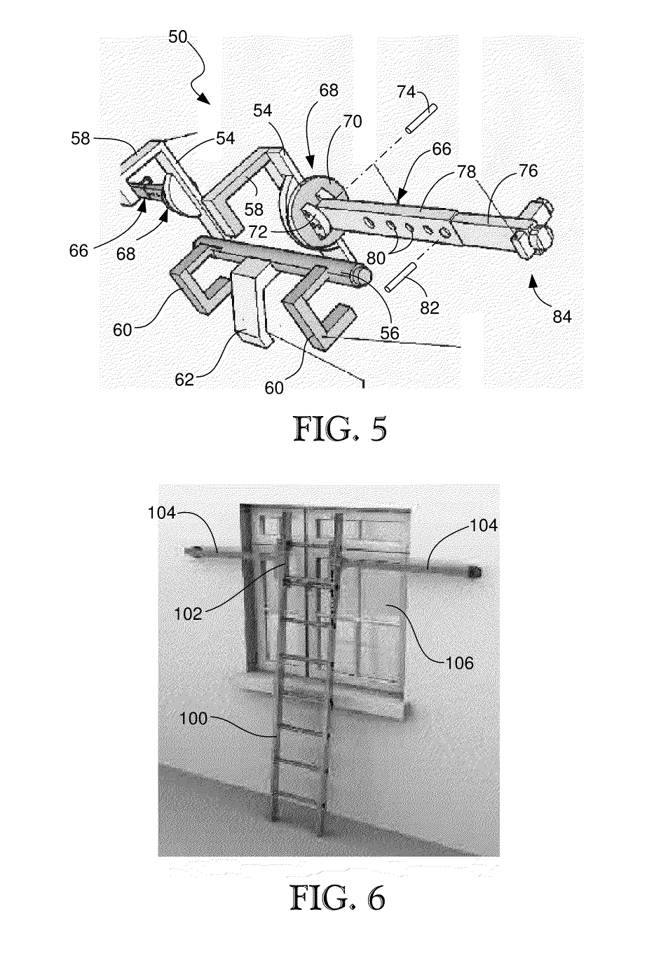

The adjustable outriggers 22, 30, 36 and 42 are part of a moveable outrigger attachment. Two perspective views of an embodiment of an adjustable outrigger attachment 50 for a ladder in accordance with the present disclosure are provided in FIGS. 3 and 5. The outrigger attachment includes a generally unitary body or frame 52, having side members 54, which are configured to be positioned along and in contact with the opposing side rails (16 in FIGS. 1-2) of a ladder. A cross bar 56 extends between and connects the side members of the frame toward the lower end of the side members. A first pair of rung hooks 58 are attached to an upper region of the opposing side members, and are configured to engage a common ladder rung. A second pair of rung hooks 60 are affixed to the cross bar 56 and configured to engage a common ladder rung at a second lower rung elevation. While four rung hooks are shown, it is believed that a functional outrigger attachment can be provided with less than four hooks. The rung hooks can have rubber pads or other resilient material upon their bearing surfaces to provide a better grip with the ladder rungs. The outrigger attachment 50 and its constituent parts can be made of a variety of materials, such as aluminum, steel, etc, with resilient bearing pads of rubber or the like.

The cross-bar 56 is axially pivotable, and can include a handle 62 to allow a user to rotate this bar so that the lower rung hooks 60 pivot to mechanically lock with the lower rung. The upper hooks 58 and lower hooks 60 can be separated by a distance that is correlated to the spacing of the ladder rungs (which is a generally standard distance) so that rotating the cross bar causes the lower hooks to wedge against the lower rung and bias the upper hooks against the upper rung, so that the outrigger frame is securely fixed to the ladder. Alternatively, the cross bar can include a locking device (not shown), which can mechanically lock the cross bar in a selected angular position after the frame 52 is attached. In either case, however, the frame is releasable from the ladder simply by rotating the cross bar to draw the lower hooks away from the respective ladder rung. Once removed, the outrigger attachment can be placed at some other desired location on the ladder. For example, it can be seen in FIG. 1A that the lower outrigger attachment is attached adjacent to the bottom rung of the ladder 10, while in FIG. 1B, the lower outrigger attachment is attached between the third and fourth rungs of the ladder.

Viewing FIGS. 3 and 5 again, the outriggers 66 are length-adjustable arms, which extend from the outrigger frame, and are attached to the side members of the frame at a double pivot, indicated generally at 68, which is positioned to be located outboard of the ladder rails when the outrigger attachment is attached to a ladder. The double pivot is pivotable about two substantially orthogonal axes. First, the pivoting mechanism includes a vertical pivot plate 70 that is rotatable about an axis that is parallel to any of the rungs of a ladder to which the outrigger attachment is attached. Attached to the vertical pivot plate is a second pivot 72, to which the proximal end of the respective outrigger arm 66 is attached. This connection allows the arm to be pivotable about a second axis that is substantially perpendicular to the first axis, so that the outriggers are pivotable in two degrees of freedom relative to the ladder and the outrigger frame. The double pivot can include multiple locking holes, for insertion of a locking pin or bolt 74 to fix the outrigger arm in a given pivotal position. Alternatively, a ratchet system, cam lock, gear drive, or other device (not shown) can be provided at the double pivot to releasably lock the outrigger arms in a desired position. The mechanism for fixing the angular position of the double pivot can be configured to allow adjustment to multiple discrete positions in both degrees of freedom, or it can be configured to allow infinite adjustment between extremes in either or both degrees of freedom. This allows the bearing pad to be placed in any of multiple locations for providing stabilization to the ladder, or for other purposes, such as providing a stand-off configuration.

The outrigger arms 66 can comprise telescoping tubes 76, 78, with multiple locking holes 80 for insertion of a pin or bolt 82 to select positions for adjusting their length. Alternatively, the outrigger arms can include a slide lock device (not shown), or use wing nuts that slide in an elongate slot along the arm (not shown), or some other mechanism to provide infinite adjustment within a given range. The outrigger arms can be rectangular in cross-section, as shown in FIG. 5, or they can be circular or some other shape. At the distal end 84 of the outrigger arms is the attachment location for a bearing pad (86 in FIG. 3).

The total length and scope of adjustability of the outrigger arms can vary. The inventor believes that outrigger arms having a maximum extension of about 5 feet per arm can be useful for many or most applications. Where the arms include two telescoping sections, as shown in FIG. 5, it will be apparent that the minimum length of adjustment of the arm will be something slightly more than half the maximum extension length. If more than two telescoping sections are used, the minimum adjustable length of a given arm will be reduced accordingly. In one embodiment, the inventor has designed outrigger arms that extend from a minimum length of about 3 feet, and a maximum length of about 5 feet, these lengths being measured from the dual pivot to the attachment point of the bearing pad. However, arms that are longer or shorter than these ranges can be used, and those of skill in the art will recognize that factors that can affect the length of the arms include the strength and weight of the arms, the weight of the ladder and the user, the way in which the ladder is to be used, etc.

With the structure described above, the position and configuration of the outrigger arms 66 is adjustable in a wide variety of ways. A perspective view of multiple adjustable outrigger attachments 50, showing the outriggers in multiple different positions, is provided in FIG. 4. In this view it is to be understood that while no ladder is shown, the outrigger attachments are all positioned with their outrigger frames 52 in a common orientation, so that a hypothetical ladder to which they might be attached would extend from upper right to lower left of the image. As shown at 90, the outrigger arms 66 can be rotated to be perpendicular to the frame 52 (and the hypothetical ladder), with the bearing pads 86 rotated in one orientation, or in an opposite orientation, as shown at 92. Alternatively, the outrigger arms 66 can be rotated to be generally parallel to the frame 52 (and the hypothetical ladder), in one direction, as shown at 94, or in another direction as shown at 96.

The outrigger system disclosed herein can be used in a wide variety of ways. Shown in FIG. 6 is a perspective view of a ladder 100 with an embodiment of an adjustable outrigger attachment 102 positioned near the top of the ladder, with the outrigger arms 104 extended laterally, substantially perpendicularly to the ladder, to provide bearing on opposing sides of a window 106. This configuration allows a user to place a ladder in a position that is convenient for working on the window or regions around it, without bearing against the window itself. This can be very useful for applications such as window washing, caulking, painting, etc.

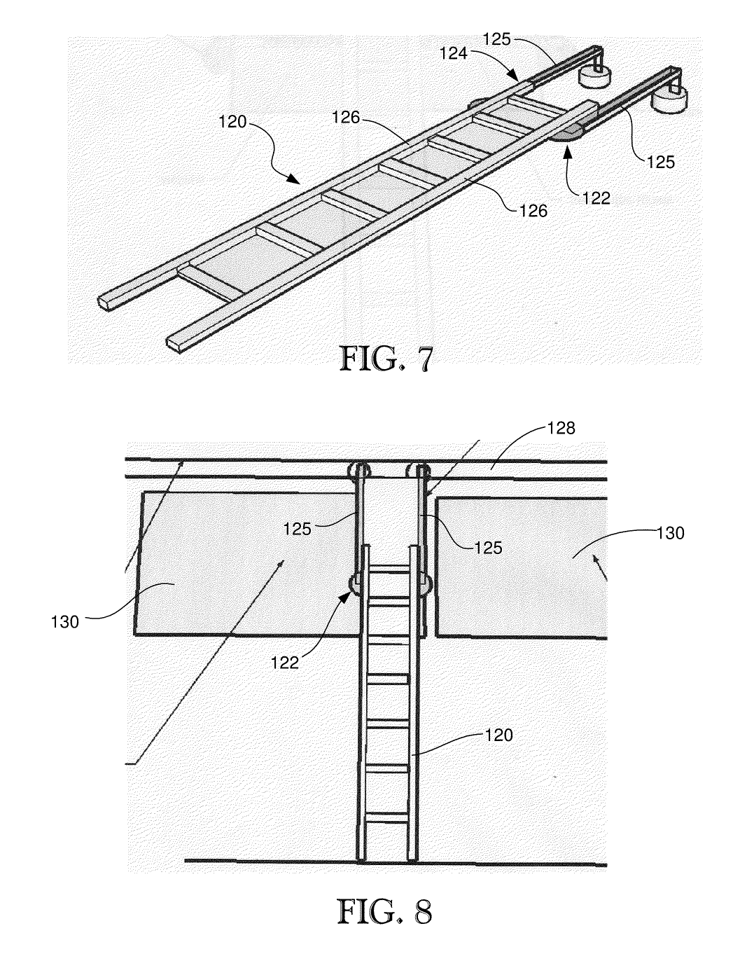

The outriggers can also be oriented to effectively extend a ladder's length. For example, shown in FIGS. 7 and 8 are views of a ladder section 120 with an embodiment of an adjustable outrigger attachment 122 positioned near an end 124 of the ladder. In this configuration, the outriggers 125 are oriented substantially parallel to the ladder rails 126, and extend beyond the end of the ladder. In this configuration, the ladder can be used in a manner like that shown in FIG. 8, with the outriggers extending upward to bear upon an eave 128 or some other structure above windows 130 or other parts of a wall 132. Depending upon the length of the outrigger arms, the length of the ladder can be effectively extended by three to six feet or more.

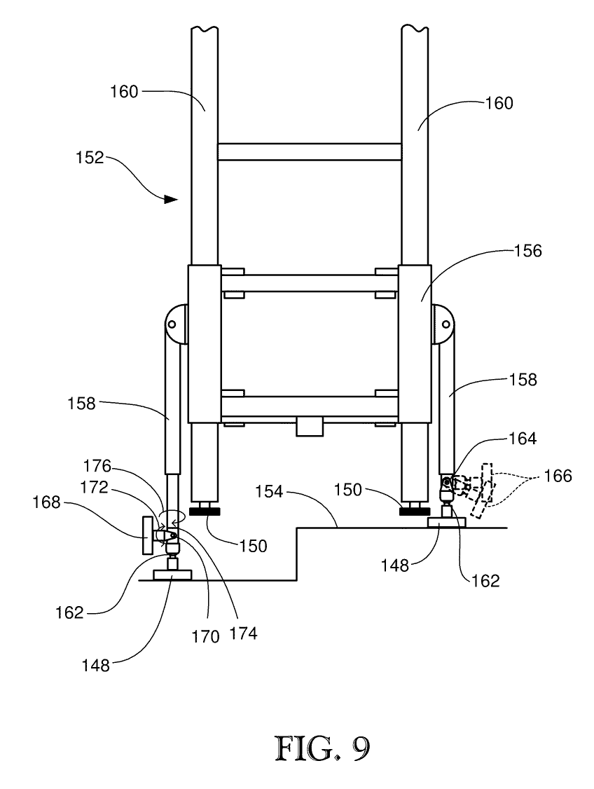

Extending the outriggers beyond the end of a ladder section can also be done for other purposes. For example, the outrigger system disclosed herein can be used as a leg leveler for a ladder, as shown in FIG. 9. In this view, it is desired to support the bearing feet 150 of a ladder 152 upon an irregular surface, such as steps 154. To help mitigate the danger of such a situation, a removable outrigger attachment 156 as disclosed herein is attached near the bottom of the ladder, and the outriggers 158 are rotated to be parallel to the ladder rails 160. With the outriggers in this position, the telescoping arms can be adjusted to place their bearing pads 148 securely on the steps 154 to provide secure support that keeps the ladder upright. This leg leveler function allows ladders to be used in locations where it might otherwise be unsafe, and without the need to place blocks or other supports under the feet of the ladder.

A wide variety of arrangements or attachment methods can be used for the bearing pads in any of the embodiments disclosed herein. As shown in FIG. 9, the bearing pad assembly 148 can be attached to the outrigger arm 158 with a ball and socket joint 162, so that it is pivotable in multiple degrees of freedom. Additionally, as shown on the right side of FIG. 9, the bearing pad (including the ball and socket assembly) can be attached to the end of the outrigger arm with a pivot 164, so that it can be rotated, such as to the positions shown in dashed lines at 166, or other angular positions, to bear either lateral or axial loads (or combinations thereof) at the end of the arm, depending on the orientation and use of the arm. This structure can allow one bearing pad to support the outrigger arms in any of the positions shown in FIGS. 1A-B, 2 and 6-9, and other positions as well.

Alternatively, as shown on the left side of FIG. 9, the distal end of the outrigger arm 158 can include a second bearing pad 168 that is oriented generally perpendicular to the first bearing pad 148. This configuration provides one bearing pad 148 for bearing axial loads upon the outrigger arm (e.g. in the leg-leveling configuration of FIG. 9) and a second bearing pad 168 for use with lateral loads upon the outrigger arm, such as shown in FIGS. 1A-B, 2 and 6-8. The second bearing pad can be attached to the end of the outrigger arm 158 by a first pivot 170, which pivots in the plane of the drawing, as represented by the arc 172. A second pivot 174 can also be provided, to allow the end of the outrigger arm to pivot about the long axis of the outrigger arm, in the direction of arc 176. This arrangement allows the second bearing pad 168 to pivot in two degrees of freedom, allowing it to rotate to the optimum position for bearing loads in a wide range of operational positions.

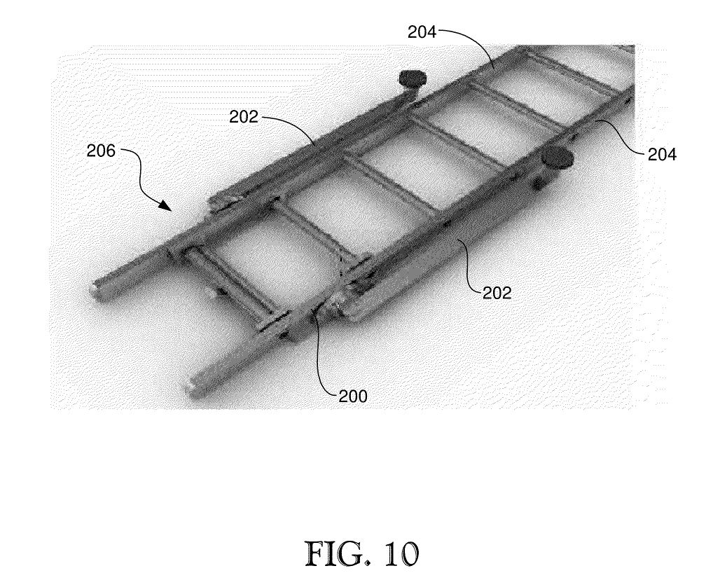

Another feature of the outrigger attachment system disclosed herein is that the system is compact and easily storable with a ladder. As shown in FIG. 10, an outrigger attachment 200 in accordance with this disclosure can have the outriggers 202 folded inward toward the side rails 204 of the ladder 206. This makes the device easily storable with a ladder. Alternatively, the outrigger attachment can be removed from the ladder and stored separately.

It is to be understood that while the outrigger system disclosed herein is described in connection with extension ladders, it is not limited to extension ladders, and can be applied to other ladders as well, including individual ladder sections. Additionally, while the adjustable outriggers are shown herein as being attached to a removable outrigger attachment frame, individual double pivot mechanisms with attached outrigger arms can be directly attached to a ladder rail, in a fixed or adjustable position along the rail. The system can be viewed in one aspect as providing a ladder, with one or more outrigger frames removably attached to it, and a pair of length-adjustable outriggers extending from the outrigger frames and being pivotable in two degrees of freedom. Alternatively, the system can be viewed as a ladder attachment including an outrigger frame that is removably attachable to a ladder, with a pair of length-adjustable outriggers extending from the outrigger frame. As another alternative, the system can be viewed as providing a ladder, with a pair of length-adjustable outriggers extend from each side rail, the outriggers being pivotable in two degrees of freedom. Multiple outrigger attachments or pairs of outrigger arms can be associated with a single ladder.

The ladder system disclosed herein can make ladder work faster, safer, and easier. The outrigger attachment can be easily installed on the top or bottom (or any other position) of a standard ladder to help ensure that ladder jobs are completed quickly and safely. This system can reduce or eliminate the need for a safetyman to hold the bottom of a ladder by providing an effective ladder stabilizer or leg leveler. It also allows an individual to set a ladder up without touching the building or surface being worked on. The outrigger arms can be locked into any angle or position within two degrees of freedom by rotating the double pivot forwards and backwards, up and down. This adjustment capability can provide additional bracing against the ground, can extend the effective length of the ladder by several feet, can allow easier access to the fascia of an overhanging eave, allows a ladder to be placed to straddle a window instead of touching the window itself, and can facilitate storage of the device and of a ladder provided with it.

It is to be understood that the above-referenced arrangements are illustrative of the application of the principles of the present invention. It will be apparent to those of ordinary skill in the art that numerous modifications can be made without departing from the principles and concepts of the invention as set forth in the claims.

What is claimed is:

1. A ladder system, comprising:
a ladder, having a pair of side rails and a plurality of rungs fixedly extending between the side rails;
a first outrigger frame, having a unitary body, removably attached to both side rails and at least one rung of the ladder; and
a pair of length-adjustable outriggers, extending from the first outrigger frame, the outriggers being pivotable in two degrees of freedom relative to the first outrigger frame, and having a bearing pad attached at a distal end thereof.

2. A ladder system in accordance with claim 1, wherein the ladder comprises an extension ladder having a bottom section and a top section slidably attached together.

3. A ladder system in accordance with claim 1, further comprising:
a second outrigger frame, having a unitary body, removably attached to both side rails and at least one rung of the ladder; and
a pair of length-adjustable outriggers, extending from the second outrigger frame, the outriggers being pivotable in two degrees of freedom relative to the second outrigger frame, and having a bearing pad attached at a distal end thereof, the second moveable outrigger frame being attached at a different vertical position along the ladder.

4. A ladder system in accordance with claim 3, wherein the first outrigger frame is located near a bottom of the ladder, and the second outrigger frame is located near a top of the ladder.

5. A ladder system in accordance with claim 1, wherein the first outrigger frame is removably attached to both side rails and at least two rungs of the ladder.

6. A ladder system in accordance with claim 5, wherein the first outrigger frame comprises:
side members, positioned along and in contact with the opposing side rails;
a cross bar connecting the side members;
a first pair of rung hooks attached to opposing side members at a first common rung elevation; and
a second pair of rung hooks attached to the cross bar at a second common rung elevation.

7. A ladder system in accordance with claim 6, wherein the cross-bar is axially pivotable, whereby the second rung hooks pivot to mechanically fix the first outrigger frame to the ladder.

8. A ladder system in accordance with claim 1, wherein the bearing pads are adjustable to bear loads selected from the group consisting of lateral loads, axial loads, and combined axial and lateral loads upon the distal ends of the outriggers.

9. A ladder system in accordance with claim 1, wherein the outriggers are adjustable to a position substantially parallel to the rails of the ladder.

10. A ladder system in accordance with claim 1, wherein the outriggers are attached to the frame at a double pivot, attached to the frame outboard of the ladder rails, the double pivot being (i) pivotable about a first axis that is parallel to a rung of the ladder, and (ii) pivotable about a second axis that is substantially perpendicular to the first axis.

11. A ladder attachment, comprising:
an outrigger frame, having a unitary body, removably attachable to opposing side rails and at least one rung of a ladder; and
a pair of length-adjustable outriggers, extending from the outrigger frame, the outriggers being pivotable in two degrees of freedom relative to the outrigger frame, and having a bearing pad attached at a distal end thereof.

12. A ladder attachment in accordance with claim 11, wherein the outrigger frame is removably attachable to opposing side rails and at least two rungs of the ladder.

13. A ladder attachment in accordance with claim 12, wherein the outrigger frame further comprises:
side members, positionable along and in contact with the opposing side rails;
a cross bar connecting the side members;
a first pair of rung hooks attached to opposing side members at a first common rung elevation; and
a second pair of rung hooks attached to the cross bar at a second common rung elevation.

14. A ladder attachment in accordance with claim 11, wherein the cross-bar is axially pivotable, whereby the second rung hooks pivot to mechanically fix the outrigger frame to the ladder.

15. A ladder attachment in accordance with claim 15, further comprising a double pivot, disposed on the outrigger frame at a position to be outboard of the ladder rails, the double pivot being (i) pivotable about a first axis that is parallel to a rung of the ladder, and (ii) pivotable about a second axis that is substantially perpendicular to the first axis.

16. A ladder, comprising:
a ladder section having a pair of side rails and rungs fixedly extending substantially perpendicularly between the side rails; and
a first pair of length-adjustable outriggers, extending from each side rail, the outriggers being pivotable in two degrees of freedom relative to the side rails, and having a bearing pad attached at a distal end thereof.

17. A ladder in accordance with claim 16, further comprising a second pair of length-adjustable outriggers, extending from each side rail at a different vertical position along the ladder section than the first pair of outriggers, the second outriggers being pivotable in two degrees of freedom relative to the side rails, and having a bearing pad attached at a distal end thereof.

18. A ladder in accordance with claim 16, wherein the first outriggers are attached via a double pivot, at an outboard location on the side rails, the double pivot being (i) pivotable about a first axis that is parallel to a rung of the ladder, and (ii) pivotable about a second axis that is substantially perpendicular to the first axis.

19. A ladder in accordance with claim 16, wherein the ladder comprises an extension ladder, having a bottom ladder section and a top ladder section slidably attached together.

20. A ladder in accordance with claim 16, wherein the bearing pads are pivotable in multiple degrees of freedom.
